(19) United States
(12) Patent Application Publication
(10) Pub. No.: US 2006/0085378 A1
(43) Pub. Date: Apr. 20, 2006

(54) Schema for physical database tuning

(75) Inventors: Alexander Raizman, Redmond, WA (US); Arunprasad P. Marathe, Redmond, WA (US); Djana Ophelia Clay Milton, Lakewood, WA (US); Dmitry Sonkin, Redmond, WA (US); Lubor J. Kollar, Redmond, WA (US); Maciej Sarnowicz, Redmond, WA (US); Manoj A. Syamala, Redmond, WA (US); Raja S. Duddupudi, Redmond, WA (US); Sanjay Agrawal, Kirkland, WA (US); Surajit Chaudhuri, Redmond, WA (US); Vivek R. Narasayya, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/966,282

(22) Filed: Oct. 15, 2004

(51) Int. Cl. G06F 17/30

(52) U.S. Cl. 707/1

(57) ABSTRACT

Internal communications within components of an automated physical database design tool may be conducted in a data description language such as XML. Inputs to and outputs from the automated physical database design tool may also be presented in the data description language (e.g., XML). The communications, inputs and outputs may comply with a schema for the data description language. The schema may be written in a schema language such as XSD. Inputs presented in the data description language may comprise tuning options. Outputs may comprise a proposed physical design for a database and reports.

### CROSS-REFERENCE TO RELATED APPLICATIONS

This application is related to U.S. patent application Ser. No. ______, Attorney Docket No. MSFT-4463/309453.1 filed concurrently herewith and which is incorporated herein by reference in its entirety.

### FIELD OF THE INVENTION

The invention relates to database tuning and in particular to making a tool for database tuning easier to use and more effective by providing input and output in a data description that may comply with a schema, is platform-independent and is self-describing and self-documenting.

### BACKGROUND OF THE INVENTION

The performance of a database system can depend to a large extent on physical design features such as indexes, indexed views and horizontal partitioning. A number of automated tools have emerged over the past several years that can help to reduce the burden on the database administrator (DBA) by helping to determine an appropriate physical design for a database.

Typically, however, software designers have to define special file formats in order to provide input to these tools. This requires writing detailed specifications and special-purpose parsers, which limits usefulness and further development of the automated tool by other parties.

It would be helpful if the input and output to such tools were expressed in a generalized data description language that is easily parsed and that complies with an agreed-upon, published or standardized schema so that special-purpose parsers, languages or dialects of languages and detailed specifications are unnecessary.

### SUMMARY OF THE INVENTION

An automated physical database design tool or database tuning tool may provide physical design recommendations or other useful information helpful in database optimization and/or management. Communications between a user and the data tuning tool and between components of the data tuning tool may occur via a data description language. Similarly, the data tuning tool may output results in a data description language. A schema may define the format of these communications. The use of the schema may minimize errors (both human and software) and encourage the creation of third-party and vendor-supplied tools and other applications built on top of the database tuning tool. Output from the tool may be optionally edited and provided as input to the database tuning tool.

One such automated physical database design tool may provide an integrated physical design recommendation for horizontal partitioning, indexes and indexed views, all three features being tuned together (in concert). Such a tool is disclosed in related patent application Attorney Docket Number MSFT-4463/309453.1 entitled “Database Tuning Advisor” filed herewith. The database tuning advisor may receive a workload of statements written in a database query language and recommend creation of a set of physical design structures to efficiently process the workload. The database tuning tool may be invoked by a command line or by a user interface. The database tuning advisor may include a number of features which are invoked via the data description language. These features may include but are not limited to the following:
Manageability requirements may be specified when optimizing for performance. For example, the tool may enable the specification that a table and its indexes should be aligned (i.e., partitioned equivalently).
User-specified configuration may enable the specification of a partial physical design without materialization of the physical design.
The tuning process may be performed for a production server but may be conducted substantially on another server.
Tuning of a database may be invoked by any owner of a database.
Usage of objects may be evaluated and a recommendation for dropping unused objects may be issued.
Reports may be provided. Exemplary reports include (but are not limited to) reports concerning the count and percentage of queries in the workload that reference a particular database, and/or the count and percentage of queries in the workload that reference a particular table or column. A feature may be provided whereby a weight may be associated with each statement in the workload, enabling relative importance of particular statements to be specified.
An in-row length for a column may be specified. If a value for the column exceeds the specified in-row length for that column, the portion of the value not exceeding the specified in-row length may be stored in the row while the portion of the value exceeding the specified in-row length may be stored in an overflow area.
Rebuild and reorganization recommendations may be generated.

Scriptability and customization may be enhanced through the use of the data description language and the schema for internal and external communications.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2a is a block diagram of a database tuning system that receives input and produces output in a specified structured language in accordance with one embodiment of the invention;

FIG. 2b is another block diagram of a database tuning system that receives input and produces output in a specified structured language in accordance with another embodiment of the invention;

FIG. 3 is an exemplary workload input in accordance with one aspect of the invention;

FIG. 4 is an exemplary tuning option input file in accordance with one aspect of the invention;

FIGS. 5a-5b is an exemplary output file in accordance with one embodiment of the invention; and

FIG. 6 is a flow diagram of a method for database tuning in which communications are conducted in a structured language in accordance with one embodiment of the invention.

### DETAILED DESCRIPTION OF ILLUSTRATIVE EMBODIMENTS

Overview

A data description language is a computer language capable of describing many different kinds of data. One purpose of a data description language is to facilitate the use and sharing of structured text and information. XML is one such language (in addition to many others including, for example, SGML, RDF, SMIL, MathML, XSIL and SVG). A document written in XML lends itself to modification and validation by generalized programs without prior knowledge of the format of the particular document because the regular, self-defining structure of an XML document simplifies parsing. Hierarchical relationships can be explicitly encoded in XML format. XML data is self-describing in that the element and attribute names can document the data that they contain. XML is equally suitable for processing by both humans and computers. Finally, XML is extensible. For these reasons and others, in accordance with some embodiments of the invention, communications between components of a database tuning tool are conducted in XML. In other embodiments, another data description language is used.

An XML schema is a description of a type of XML document, typically expressed in terms of constraints on the structure and content of documents of that type, above and beyond the basic constraints imposed by XML itself. In accordance with some embodiments of the invention, XML communications between components of the database tuning tool comply with an XML schema. The schema may include elements that describe concepts (e.g., servers, databases, workloads, configurations etc.) that may be an essential part of a physical database design tuning tool.

A number of standard and proprietary XML schema languages have been developed for the purpose of formally expressing schemas, and some of these languages are themselves based on XML. One popular XML schema language is XML Schema Definition (XSD). XSD uses an XML based format. In some embodiments of the invention, the schema is an XSD schema.

The careful choice of XML element names allows the meaning of the data to be retained as part of the markup, making the document more easily interpreted by software programs and humans.

Exemplary Computing Environment

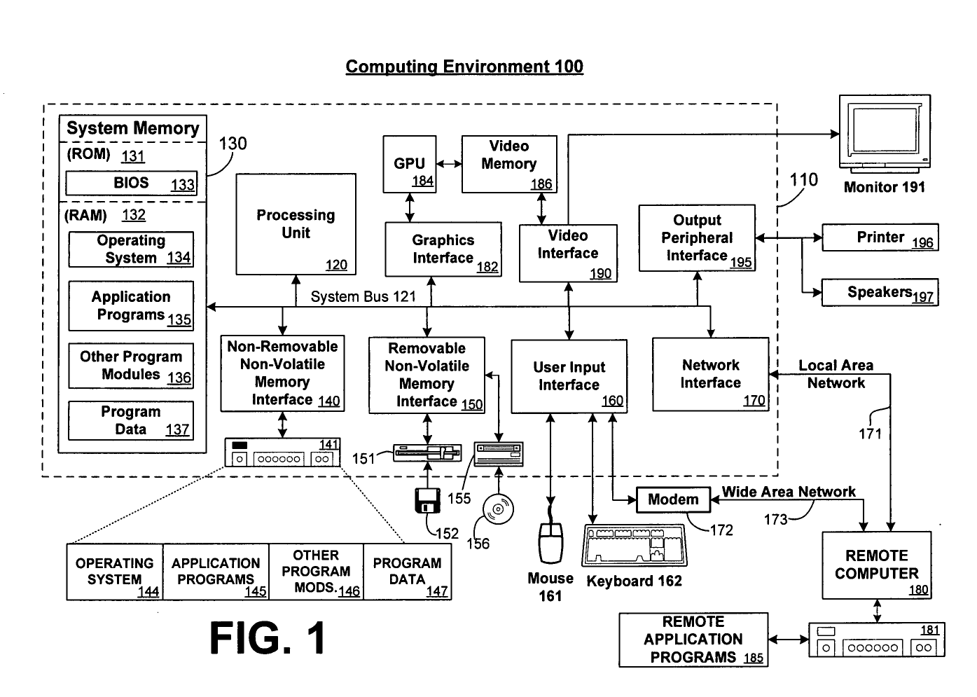

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Database Tuning Tool in Which Communications are Conducted in a Data Description Language

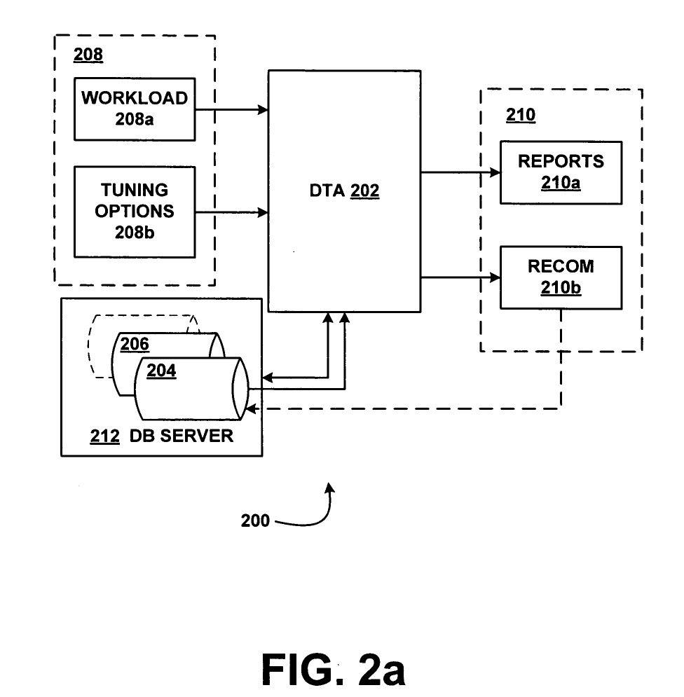

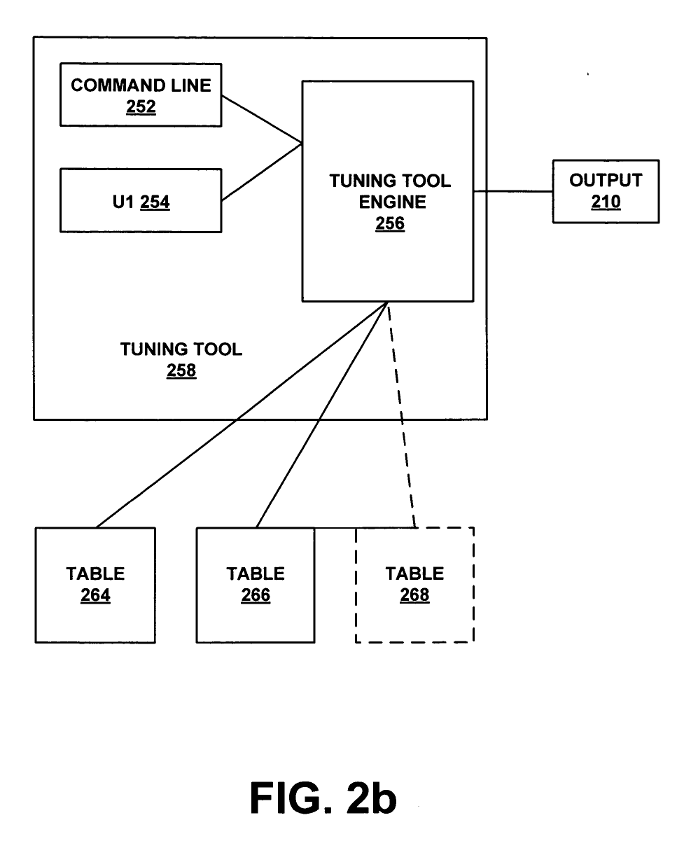

FIG. 2 is a block diagram of an exemplary system for tuning a database in which communications are conducted in a data description language in accordance with one embodiment of the invention. System 200 may reside on one or more computers, each of which may be a computer such as computer 110 described above with respect to FIG. 1.

System 200 may include one or more of the following components: a database tuning tool 202, one or more database(s) to be tuned or referenced 204, 206, etc., input 208 and output 210. Databases 204, 206, etc. may also be input to the database tuning tool 202. A database tuning tool may be invoked via a command line executable, a user interface or by other suitable means.

Database tuning tool 202 in some embodiments of the invention is a database tuning advisor for physical design tuning and may reside on one or more test or production (database) servers. In some embodiments of the invention, as illustrated in FIG. 2b, the database tuning tool 258 may comprise one or more of: a command line executable 252, a user interface 254 and a tuning tool engine 256. In some embodiments of the invention, the tuning tool 258 may be invoked from a user interface 254 (e.g., a graphical user interface) or from a command-line executable 252. Communications between these and potentially other components of the tuning tool 258 in some embodiments of the invention are conducted in a data description language. The communications may comply with a specified, published or standardized schema. In some embodiments of the invention, the data description language used for communication is XML and the XML schema may be written in XML Schema language (XSD). During processing, one or more physical structures, here represented as table 264, table 266 . . . table 268 may be generated. These tables may also comprise XML statements.

Input 208 may include one or more databases (e.g., database 204, database 206, etc.), which typically reside on one or more separate servers, such as database server 212, although the invention is not so limited.

Input 208 may also include a workload 208a to tune. A workload may include a set of statements that may execute against the database server. The statements may be written in a language for creating, updating and, querying relational database management systems, such as SQL, TSQL, CODASYL, SQL3, QUEL, XPointer, Xpath, OQL or another database language. One or more of the statements in the workload may be associated with a weight representing the relative importance of the statement to the performance of the database system. A workload may be a file including an organization or industry benchmark, may be obtained from a profiling tool or may be generated in any suitable way.

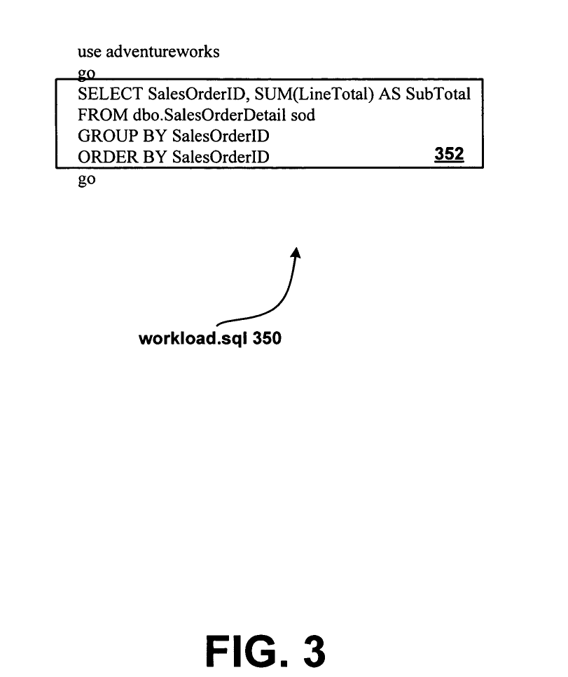

FIG. 3 is a sample of a possible workload file 350 called “workload.sql”. The sample workload file workload.sql 350 contains one query 352 that may be given to a database tuning tool for tuning, although it will be understood that a workload input to the database tool may include any suitable number of queries. In some embodiments of the invention an output file is generated by invoking the tool using a command-line executable, such as command line executable 252 of FIG. 2b. A sample command-line may be, for example:
dta -S arunmadsktp -E -s session1 -ix dtainput.xml -ox dtaoutput.xml

The command-line above instructs the database tuning tool (dta) to tune the workload on a database server such as SQL Server, DB2, etc., called “arunmadsktp”. The “-ix” and “-ox” options may name the input (dtainput.xml) and output (dtaoutput.xml) specification files, respectively. It will be understood that the command line presented here is exemplary only, the database tuning tool may be invoked by any suitable command-line. Similarly, the database tuning tool may also be invoked by other means, such as, for example, via a user interface or via other suitable means.

Input 208 may include tuning options 208b. Tuning options as used herein are broadly defined to include one or more of: a feature to be tuned, an alignment constraint, a partial physical configuration (e.g., a clustered index on a table, partitioning of a table or indexed view may be specified as required), a storage constraint (e.g., an upper bound of storage consumption), a time constraint, a logging condition and so on. Exemplary but non-limiting tuning options are discussed below.

In some embodiments of the invention, tuning options are provided in a language that is capable of describing many different kinds of data. Suitable languages include languages based on XML (for example, RDF, SMIL, MathML, XSIL and SVG are non-limiting examples of suitable languages) or other languages capable of describing hierarchical data.

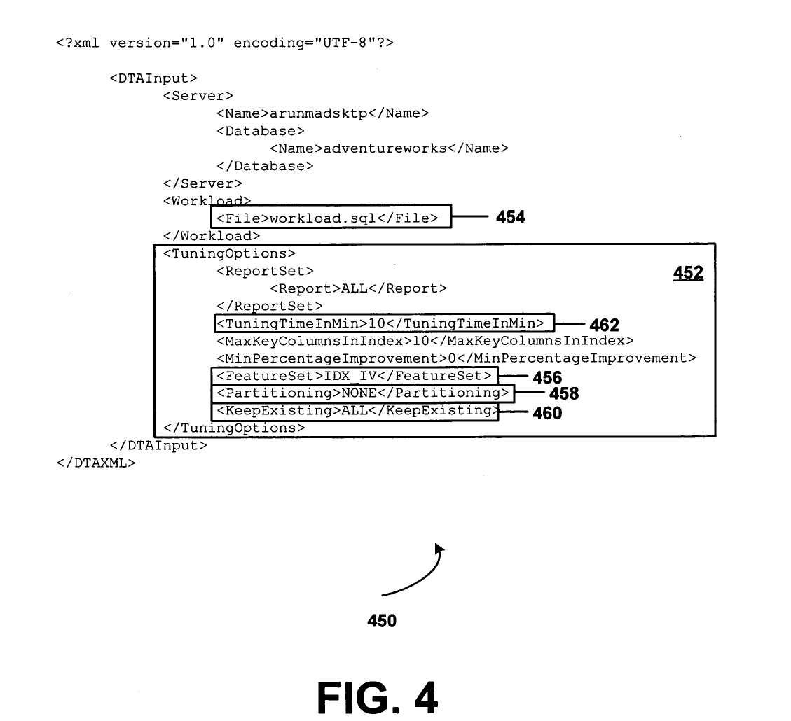

FIG. 4 illustrates a sample input file 450 that may be associated with the sample workload 350 illustrated in FIG. 3. The input file “dtainput.xml” 450 includes sample tuning options 452. The name of the workload file (“workload.sql”) may appear in a <File> element 454. The sample input file “dtainput.xml” 450 directs the database tuning tool to propose indexes and indexed views (<FeatureSet> element 456), to not propose any partitioning-related physical design structures (<Partitioning> element 458), to keep (that is, not drop) any of the existing physical design structures (<KeepExisting> element 460), to use at most 10 minutes for tuning (<TuningTimeInMin> element 462), and so on. Because of the ability to specify detailed tuning options using the input XML file 450, the command-line invocation itself is greatly simplified.

Output 210 may include one or more reports 210a and a physical design recommendation 210b and may include a recommendation to create one or more indexes and indexed views. Output may be provided in a language or format this is easily parsed such as, for example, XML, HTML, etc.

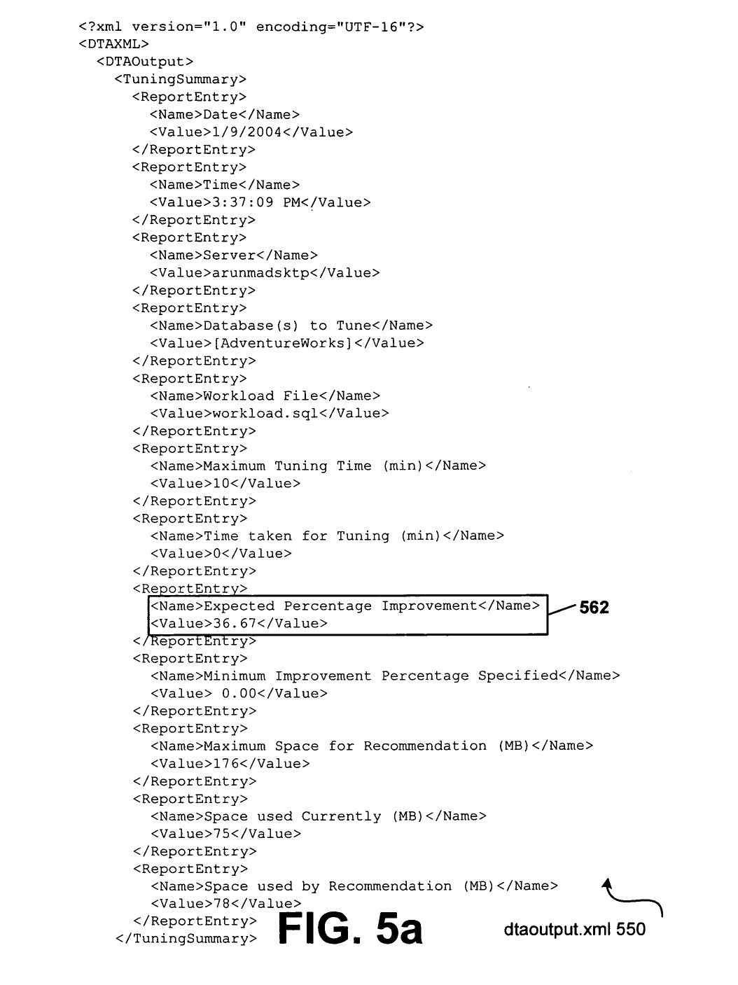

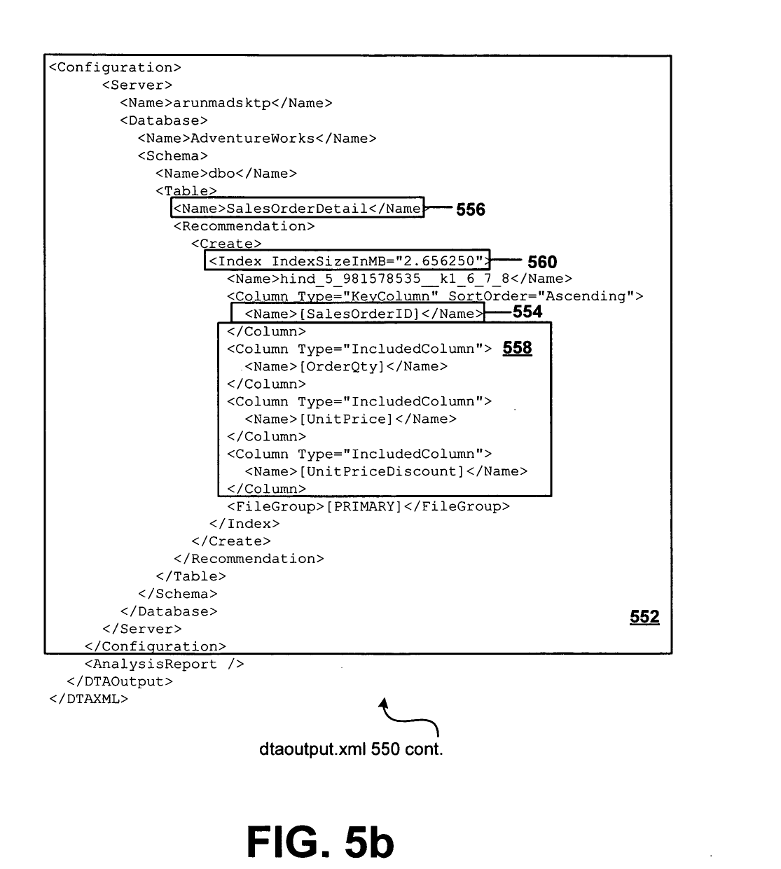

FIGS. 5a and 5b illustrate a sample output file, “dtaoutput.xml” 550, representing recommendations provided by the database tuning tool. The “dtaoutput.xml” 550 file indicates that database tuning tool has proposed building a non-clustered index on the “SalesOrderID” column 554 of the “SalesOrderDetail” table 556 in the <Configuration> element 552.) The database tuning tool also proposes to have this non-clustered index include three additional columns, as illustrated by block 558. The database tuning tool estimates that this new index will occupy approximately 2.7 MB of disk space 560, and that building this index is likely to improve the performance of the query contained in “workload.sql” by about 37% 562.

It will be appreciated that the output illustrated in FIGS. 5a and 5b is sample output only. Any suitable output may be generated.

In some embodiments of the invention, the database tuning tool may be constrained to propose only those physical design structures that support online operations. An online physical design structure may continue to be available to a user when it is being rebuilt. More details may appear near an <OnlineIndexOperation> element (not shown).

Output 210 may also include a recommendation to partition tables, indexes and indexed views. The relevant elements in the output may be identified by the word “Partition” in their names—for example, <PartitionFunctionType> and <PartitionType>.

Dropping existing physical design structures may also be recommended in the output 210. The database tuning advisor 202 may produce a set of workload analysis reports that describe usage of databases, tables, and columns. In some embodiments of the invention, details appear near an <AnalysisReportType> element.

Reports may be generated in a data description language such as (but not limited to) XML. In particular, a “Database usage report” may show the count and percentage of queries in the workload that reference a particular database. Similarly, a “Table usage” and “Column Usage” report may show the count and percentage of queries in the workload that reference a particular table or column. These reports may be useful to a DBA for identification of frequently accessed objects on the server.

Possible tuning options are discussed below. The options may be invoked by inclusion of a request in a data description language such as (but not limited to) XML, for example, or by default.

Multi-Database Tuning

Database applications often issue stored procedure calls or queries that reference more than one database or have different queries that reference different databases. Hence, the workload that is input to the database tuning tool may reference more than one database. In some embodiments of the invention, the database tuning advisor 202 may recommend an appropriate physical design for multiple databases together. A recommendation for how available storage space should be allocated across databases may also be provided.

Integration of Selection of Indexes, Indexed Views and Partitioning

In accordance with some embodiments of the invention, partitioning recommendations and recommendations for required indexes and indexed views are made in concert, that is, the database tuning advisor 202 may recommend one or more indexes, indexed views and partitioning in an integrated manner.

In some embodiments of the invention, in a “drop-only” mode, the database tuning advisor 202 evaluates usage of existing physical design objects for the given workload and recommends dropping unused objects. This option may be useful, for example, when a large number of physical design objects have accumulated over time and a DBA wishes to reduce storage and update cost by dropping unused objects.

Partitioning

Partitioning is likely to affect the performance and manageability of a relational database system. It is desirable to identify regions of the database (data) that are frequently accessed and to support such access with the selected physical design. Two common types of horizontal partitioning are range and hash partitioning. Horizontal partitioning allows access methods such as tables, indexes and indexed views to be partitioned into disjoint sets of rows that are physically stored and accessed separately. Like indexes and indexed views, partitioning can significantly impact the performance of a workload by reducing the cost of accessing and processing data. In some embodiments of the invention, the database tuning advisor considers characteristics of the workload and the presence of other related physical objects in making partitioning recommendations, and thus may enable efficient access with little increase in needed space and may significantly reduce the amount of data that has to be scanned to reply to a query, thus impacting performance.

In response to receiving a tuning option that specifies that a table or index is to be partitioned, the database tuning advisor may recommend appropriate range or hash partitioning of tables and indexes. In some embodiments of the invention, a tuning option may specify whether new indexes and indexed views (also referred to herein as objects) should be partitioned or not partitioned. If the option specifies that indexes and indexed views are to be partitioned, an alignment option may specify whether the partitioning of all indexes and indexed views on a table are to be aligned, as described below.

Alignment of Partitions

A table and its associated indexes are aligned if the table and its indexes are partitioned equivalently. In some embodiments of the invention, the database tuning advisor 202 enables specification that the physical design is to be aligned. Aligning a table and all its indexes (i.e., partitioning the table and its indexes equivalently) is likely to make partition operations such as add/remove/backup/restore easier. Alignment may also enable partitioned joins whereby the complete join operation (a potentially costly operation) need not be performed, but only the necessary pieces of the join operation need to be performed. The output recommendations 210b produced in response to receiving this option satisfy the alignment property.

In response to receiving a tuning option that specifies that a table or index is to be partitioned, and that an “aligned” option is selected, the database tuning advisor may propose that each recommended index be aligned, or partitioned in the same way as the table over which the index is defined. Similarly, the database tuning advisor may propose that each recommended non-clustered index be aligned, or partitioned in the same way as the indexed view over which the non-clustered index is defined. Aligning a table or indexed view and all its indexes (i.e., partitioning the table and its indexes equivalently) is likely to make database operations such as backup/restore or adding/removing partitions easier.

Tuning Performed on Test Server

The tuning process may impose a significant load on a database server. Hence, test servers are commonly used for tuning. One way to reduce the impact on a production server is to copy the database(s) to be tuned from the production server to the test server, perform the tuning on the test server and apply the changes to the production server. As databases are frequently large (hundred of gigabytes or larger), one problem with this approach is that copying large amounts of data from production to test for the purposes of tuning can be time-consuming and resource intensive. Furthermore, because the hardware characteristics of a test server and a production server are typically different, and tuning recommendations are dependent on hardware characteristics, recommendations suitable for the test server may not be optimal for the production server.

In some embodiments of the invention, therefore, the database tuning advisor 202 may significantly reduce the load imposed on the production server by tuning the production server on another server (e.g., a test server) by copying only metadata of the databases to be tuned from the production server to the test server. FIG. 3 illustrates such a system. Exemplary system 300 comprises a production server 302 with associated metadata 304, a test server 306 and a database tuning advisor 202. Database tuning advisor may reside on test server 306 or on another server. Data is not copied from the production server to the test server, only empty tables, indexes, views, stored procedures, triggers, and so on. The metadata may be imported using scripting that typically accesses catalog entries and is not size-dependent.

The workload 208a thus may be tuned on a non-production server, importing from or creating on the production server any statistics that may be necessary. Hardware parameters of the production server may be modeled on the test server so that the tuning recommendations determined are tuning recommendations for the production server, not the test server. Hence the recommendations produced by database tuning advisor 202 are the same as if the tuning were performed on the production server itself.

In-Row Length Tuning

In some embodiments of the invention, for certain data types such as but not limited to text, ntext, and varchar(max) an option may be provided for specifying an in-row length for the column. In some embodiments, any row of the column whose length is less than or equal to the specified value is stored in-row (i.e., along with other columns of the table). If the length is greater than the specified value, the data is not stored in the row, but instead in an overflow area. In some embodiments of the invention, an appropriate in-row length value for a column is recommended, the recommended value depending on the distribution of the lengths of the rows and the workload.

User-Specifiable Configurations

In some embodiments of the invention the database tuning advisor 202 enables a user to provide a desired configuration (e.g., a valid set of indexes, indexed views, and statistics) to be interpreted by the database tuning advisor 202. In some embodiments of the invention, in an evaluate mode, the performance of the given workload is evaluated (e.g., by consulting a query optimizer, or by executing embedded code, or by any other suitable means) for the configuration specified by the user and compared with the current configuration in the database. Thus, in this mode, DBAs may perform a “what-if” analysis of the physical design and assess its impact on the workload without actually changing the physical design of the database (e.g., such as by materializing the proposed structures) or executing the queries in the workload. In some embodiments of the invention, the database tool can evaluate a physical design structure (called a “configuration”) by costing queries in the workload against the design structure. This “evaluate” mode (as opposed to the more common “tune” mode) may be captured in the schema under an <EvaluateConfiguration> element.

In some embodiments of the invention, in a tune mode, the database tuning advisor 202 may tune the workload 208a and provide a recommendation 210b. The specified configuration may be treated as “must include”, i.e., the recommendation provided by the database tuning advisor 202 will contain the indexes, indexed views, and statistics specified in the provided configuration. The database tuning advisor 202 may recommend other indexes, indexed views, etc. in addition to the specified configuration. This mode may be useful to DBAs for achieving manageability in addition to other reasons. For example, it may be known that a particular table should be partitioned in a particular way. This requirement may be specified in the user-specified configuration, resulting in the selection of the best set of aligned indexes on that table, i.e., having the same partitioning by the database tuning advisor 202.

Index-Able XML Columns

In some embodiments of the invention, a new data type called XML may be processed. Indexes may be created on XML columns in some embodiments. The database tuning advisor 202 may recommend appropriate secondary indexes on XML columns based on the workload.

Database Owners May Invoke Tuning Tool

In some embodiments of the invention, the invoker of the database tuning advisor 202 may be an owner (i.e., does not need to be a system administrator).

User-Specified Query Weights

In some embodiments of the invention, user-specified query weight may enable a user to assign relative importance to each query in the workload. A weight may be specified with each statement in the workload. In some embodiments of the invention, the database tuning advisor 202 may incorporate these weights into its analysis, and recommend a physical design that is suited for a given (weighted) workload.

Rebuild/Reorganization Recommendations

Indexes typically become fragmented over time. Fragmentation may lead to increased cost of scanning or lookup, thereby degrading overall performance. In some embodiments of the invention, the database tuning advisor 202 analyzing the fragmentation and usage of existing indexes in the database(s), and provides a list of indexes that should be rebuilt or reorganized.

Schema for Communications

An exemplary schema for the XML input and output and potentially other communications between elements of the database tuning tool may include one or more of the following elements:

A root element, which in some embodiments is defined by the following schema element:

```
<xsd:element name=“DTAXML”>
    <xsd:complexType>
        <xsd:sequence>
            <xsd:element name=“DTAInput” type=“DTAInputType”
minOccurs=“0” />
            <xsd:element name=“DTAOutput” type=“DTAOutputType”
minOccurs=“0” />
        </xsd:sequence>
    </xsd:complexType>
  </xsd:element>
```

input (arguments or a user-specified configuration) which in some embodiments is defined by the following schema element:

```
  <xsd:complexType name=“DTAInputType”>
    <xsd:sequence>
      <xsd:element name=“Server” type=“ServerType”
maxOccurs=“unbounded” />
      <xsd:element name=“Workload” type=“WorkloadType” />
      <xsd:element name=“TuningOptions” type=“TuningOptionsType”
minOccurs=“0” />
      <xsd:element name=“Configuration” type=“ConfigurationType”
minOccurs=“0” />
    </xsd:sequence>
  </xsd:complexType>
```

output (header, output configuration and reports) which in some embodiments is defined by the following schema element:

```
  <xsd:complexType name=“DTAOutputType”>
    <xsd:sequence>
      <xsd:element name=“TuningSummary”
      type=“TuningSummaryType” />
      <xsd:element name=“Configuration” type=“ConfigurationType”
minOccurs=“0” />
      <xsd:element name=“AnalysisReport” type=“AnalysisReportType”
minOccurs=“0” />
      <xsd:element name=“Error” type=“ErrorType” minOccurs=“0”
maxOccurs=“unbounded” />
    </xsd:sequence>
  </xsd:complexType>
```

a format for command-line arguments to the database tuning tool (may be required or optional) which in some embodiments is defined by the following schema element:

```
  <xsd:complexType name=“ServerType”>
    <xsd:sequence>
      <xsd:element name=“Name” type=“xsd:string” />
      <xsd:element name=“Database” type=“DatabaseType”
maxOccurs=“unbounded” />
    </xsd:sequence>
  </xsd:complexType>
```

Database type, list of database names, which in some embodiments is defined by the following schema element:

```
  <xsd:complexType name=“DatabaseType”>
    <xsd:sequence>
      <xsd:element name=“Name” type=“xsd:string” />
      <xsd:choice maxOccurs=“unbounded”>
        <xsd:element name=“Recommendation”
type=“RecommendationPType” minOccurs=“0”
maxOccurs=“unbounded”/>
        <xsd:element name=“Schema” type=“SchemaType”
minOccurs=“0” maxOccurs=“unbounded” />
      </xsd:choice>
    </xsd:sequence>
  </xsd:complexType>
```

Schema type—refers to owner which in some embodiments is defined by the following schema element:

```
  <xsd:complexType name=“SchemaType”>
    <xsd:sequence>
      <xsd:element name=“Name” type=“xsd:string” />
      <xsd:choice maxOccurs=“unbounded”>
        <xsd:element name=“Recommendation”
type=“RecommendationViewType”/>
        <xsd:element name=“Table” type=“TableType”/>
        <xsd:element name=“View” type=“ViewType”/>
      </xsd:choice>
    </xsd:sequence>
  </xsd:complexType>
```

table definition which in some embodiments is defined by the following schema element:

```
  <xsd:complexType name =“DatabaseDetailsType”>
    <xsd:sequence>
      <xsd:element name=“Name” />
      <xsd:element name=“Schema”>
        <xsd:complexType>
          <xsd:sequence>
            <xsd:element name=“Name” />
            <xsd:element name=“Table”>
              <xsd:complexType>
                <xsd:sequence>
                  <xsd:element
name=“Name”/>
                </xsd:sequence>
              </xsd:complexType>
            </xsd:element>
          </xsd:sequence>
        </xsd:complexType>
      </xsd:element>
    </xsd:sequence>
  </xsd:complexType>
```

a WorkloadFileType (can be a workload file or a list of tables) which in some embodiments is defined by the following schema element:

```
<xsd:complexType name=“WorkloadType”>
  <xsd:choice>
      <xsd:element name=“File” type=“xsd:string” />
      <xsd:element name=“Database” type=“DatabaseDetailsType”/>
      <xsd:sequence>
        <xsd:element name=“EventString” maxOccurs=“unbounded”>
          <xsd:complexType>
            <xsd:simpleContent>
              <xsd:extension base=“xsd:string”>
                <xsd:attribute name =“Weight”
use=“optional” >
                  <xsd:simpleType >
                    <xsd:restriction
base=“xsd:float”>
  <xsd:minExclusive value=“0”/>
                    </xsd:restriction>
                  </xsd:simpleType>
                </xsd:attribute>
              </xsd:extension>
            </xsd:simpleContent>
          </xsd:complexType>
        </xsd:element>
      </xsd:sequence>
    </xsd:choice>
  </xsd:complexType>
```

Optional arguments which in some embodiments is defined by the following schema element:

```
  <xsd:complexType name=“TuningOptionsType”>
    <xsd:sequence>
      <!--Report set maps to a choice of reports user would want to generate!-->
      <xsd:element name=“ReportSet” minOccurs=“0”>
        <xsd:complexType>
          <xsd:sequence minOccurs=“0”>
            <xsd:element name=“Report”
maxOccurs=“unbounded”>
              <xsd:simpleType>
                <xsd:restriction base=“xsd:string”>
                  <xsd:enumeration
value=“ALL” />
                  <xsd:enumeration
value=“NONE” />
                  <xsd:enumeration
value=“QRY_COST” />
                  <xsd:enumeration
value=“EVT_FREQ” />
                  <xsd:enumeration
value=“QRY_DET” />
                  <xsd:enumeration
value=“CUR_QRY_IDX” />
                  <xsd:enumeration
value=“REC_QRY_IDX” />
                  <xsd:enumeration
value=“CUR_QRY_COSTRANGE” />
                  <xsd:enumeration
value=“REC_QRY_COSTRANGE” />
                  <xsd:enumeration
value=“CUR_IDX_USAGE” />
                  <xsd:enumeration
value=“REC_IDX_USAGE” />
                  <xsd:enumeration
value=“CUR_IDX_DET” />
                  <xsd:enumeration
value=“REC_IDX_DET” />
                  <xsd:enumeration
value=“VIW_TAB” />
                  <xsd:enumeration
value=“WKLD_ANL” />
                  <xsd:enumeration
value=“DB_ACCESS” />
                  <xsd:enumeration
value=“TAB_ACCESS” />
                  <xsd:enumeration
value=“COL_ACCESS” />
                </xsd:restriction>
              </xsd:simpleType>
            </xsd:element>
          </xsd:sequence>
        </xsd:complexType>
      </xsd:element>
      <!--This is used to specify the table that DTA will use to output events
that could not be tuned !-->
      <xsd:element name=“TuningLogTable” minOccurs=“0”>
        <xsd:complexType>
          <xsd:sequence minOccurs =“0”>
            <xsd:element name=“Database”
type=“DatabaseDetailsType”/>
          </xsd:sequence>
        </xsd:complexType>
      </xsd:element>
      <!--Number of events to be tuned!-->
      <xsd:element name=“NumberOfEvents” type=“xsd:unsignedInt”
minOccurs=“0” />
      <!--Specifies the tuning time in minutes, and is a required option unless
NumberofEvents is specified!-->
      <xsd:element name=“TuningTimeInMin” type=“xsd:unsignedInt”
minOccurs=“0” />
      <!-- If either of “NumberOfEvents” and “TuningTimeInMin” are absent, the other
defaults to infinite. -->
      <!-- If both of “NumberOfEvents” and “TuningTimeInMin” are present, the
earlier of the two events -->
      <!-- determines when tuning will terminate. --
>
        <!--Specifies the maximum space in megabytes that can be consumed
recommendation!-->
        <xsd:element name=“StorageBoundInMB” type=“xsd:unsignedInt”
minOccurs=“0” />
        <!--Specifies the maximum number of key columns in indexes proposed
by DTA!-->
        <xsd:element name=“MaxKeyColumnsInIndex”
type=“MaxKeyColumnsInIndexType” minOccurs=“0” />
        <!--Specifies the maximum number of columns (key and non key) in
indexes proposed by DTA!-->
        <xsd:element name=“MaxColumnsInIndex”
type=“MaxColumnsInIndexType” minOccurs=“0” />
        <!--Specifies the minimum improvement for DTA to propose a
configuration!-->
        <xsd:element name=“MinPercentageImprovement” type=“xsd:int”
minOccurs=“0” />
        <!--Specifies the test server on which the tuning will be done!-->
        <xsd:element name=“TestServer” type=“xsd:string” minOccurs=“0” />
        <xsd:choice>
          <xsd:element name=“EvaluateConfiguration”/>
          <!--Choose the feature set and partitioning options OR
          Choose to use drop only mode !-->
          <xsd:sequence>
            <xsd:choice>
              <xsd:sequence>
                <!--
                  FeatureSet represents the
class of physical design structures that will be considered
                  by the tuning engine
                  IDX - Indexes
                  IV - Index Views
                  IDX_IV - Indexes and Index
Views
                  NCL_IDX - Non Clustered
Indexes
                !-->
              <xsd:element name=“FeatureSet”>
                <xsd:simpleType>
                  <xsd:restriction
base=“xsd:string”>
                    <xsd:enumeration
value=“IDX” />
                    <xsd:enumeration
value=“IV” />
                    <xsd:enumeration
value=“IDX_IV” />
                    <xsd:enumeration
value=“NCL_IDX” />
                  </xsd:restriction>
                </xsd:simpleType>
              </xsd:element>
              <!--
                Partitioning represents the way the
physical design structures considered will be partitioned
                by the tuning engine
                NONE - No partitioning
                FULL - Full partitioning
                ALIGNED - Aligned partitioning
              !-->
              <xsd:element name=“Partitioning”>
                <xsd:simpleType>
                  <xsd:restriction
base=“xsd:string”>
                    <xsd:enumeration
value=“NONE” />
                    <xsd:enumeration
value=“FULL” />
                    <xsd:enumeration
value=“ALIGNED” />
                  </xsd:restriction>
                </xsd:simpleType>
              </xsd:element>
            </xsd:sequence>
            <!--
                Suggest which physical design structures
can be dropped.No new physical design structures are
                recommended in this mode, the physical
design structures not used by the workload
                are suggested to be dropped.
              !-->
              <xsd:element name=“DropOnlyMode” />
            </xsd:choice>
            <!--
              KeepExisting refers to which existing physical
design structures in
              the database must be part of DTAâε ™ s
recommendation
              NONE - Drop all
              ALL - Keep All
              CL_IDX - Keep Clustered Indexes
              ALIGNED - Keep Aligned
              IDX -Keep Indexes
            !-->
            <xsd:element name=“KeepExisting”>
              <xsd:simpleType>
                <xsd:restriction base=“xsd:string”>
                  <xsd:enumeration value=“NONE” />
                  <xsd:enumeration value=“ALL” />
                  <xsd:enumeration value=“CL_IDX”
/>
                  <xsd:enumeration
value=“ALIGNED” />
                  <xsd:enumeration value=“IDX” />
                </xsd:restriction>
              </xsd:simpleType>
            </xsd:element>
          </xsd:sequence>
        </xsd:choice>
        <xsd:element name=“OnlineIndexOperation” minOccurs=“0”>
          <xsd:simpleType>
            <xsd:restriction base=“xsd:string”>
              <xsd:enumeration value=“ON” />
              <xsd:enumeration value=“OFF” />
              <xsd:enumeration value=“MIXED” />
            </xsd:restriction>
          </xsd:simpleType>
        </xsd:element>
        <!--Specifies the database to connect!-->
        <xsd:element name=“DatabaseToConnect” type=“xsd:string”
minOccurs=“0”/>
      </xsd:sequence>
    </xsd:complexType>
    <!--
  ** Maximum number of key columns
    <xsd:simpleType name=“MaxKeyColumnsInIndexType”>
      <xsd:restriction base=“xsd:unsignedInt”>
        <xsd:minExclusive value=“0” />
        <xsd:maxInclusive value=“16” />
      </xsd:restriction>
    </xsd:simpleType>
Maximum number of columns
    <xsd:simpleType name=“MaxColumnsInIndexType”>
      <xsd:restriction base=“xsd:unsignedInt”>
        <xsd:minExclusive value=“0” />
        <xsd:maxInclusive value=“1024” />
      </xsd:restriction>
    </xsd:simpleType>
```

Summary of the work done by tuning engine which in some embodiments is defined by the following schema element:

```
  <xsd:complexType name=“TuningSummaryType”>
    <xsd:sequence>
      <xsd:element name=“ReportEntry” type=“ReportEntryType”
maxOccurs=“unbounded” />
    </xsd:sequence>
  </xsd:complexType>
  <!--
ReportEntryType is a Name/Value Pair
  <xsd:complexType name=“ReportEntryType”>
    <xsd:sequence>
      <xsd:element name=“Name” type=“xsd:string” />
      <xsd:element name=“Value” type=“xsd:string” />
    </xsd:sequence>
  </xsd:complexType>
```

error Type which in some embodiments is defined by the following schema element:

```
  <xsd:complexType name=“ErrorType”>
    <xsd:annotation>
      <xsd:documentation source=“\\autoadmin5\Yukon\external\ITW-
Error-Messages.doc”>
        Workload Errors
          1.Empty workload.
          2.No parseable events in workload.
          3.No tunable statements in workload.
        Recommendation
          1.Improvement of best solution found is below minimum
specified
          improvement.
          2.Insufficient storage.
          3.Recommending solution with negative improvement
since storage limit
          specified is less than current storage.
        Other
          1.Connection timed out. Connection to server timed out.
          2.Server returned error.
          3.Insufficient memory. DTA ran out of memory while
tuning.
      </xsd:documentation>
    </xsd:annotation>
    <xsd:attribute name=“Source” type=“xsd:string” use=“optional” />
    <xsd:attribute name=“Description” type=“xsd:string”
    use=“optional” />
    <xsd:attribute name=“ErrorCode” type=“xsd:string”
    use=“optional” />
  </xsd:complexType>
```

ConfigurationType (refers to an absolute or relative (delta) configuration. In the relative sense the configuration is a delta with respect to current configuration whereas absolute refers to a stand alone absolute configuration) which in some embodiments is defined by the following schema element:

```
    <xsd:complexType name=“ConfigurationType”>
        <xsd:sequence minOccurs=“0”>
            <xsd:element name=“Server” type=“ServerType” />
        </xsd:sequence>
        <xsd:attribute name=“SpecificationMode” type=
“SpecificationModeType” default=“Relative” />
    </xsd:complexType>
```

Table type—list of table names which in some embodiments is defined by the following schema element:

```
    <xsd:complexType name=“TableType”>
        <xsd:sequence>
            <xsd:element name=“Name” type=“xsd:string” />
            <xsd:element name=“Recommendation”
type=“RecommendationType” minOccurs=“0” />
        </xsd:sequence>
        <xsd:attribute name=“NumberOfRows” type=“xsd:integer”
        use=“optional” />
    </xsd:complexType>
```

View (If there is a Recommendation node and no ViewDefinition node it means the Recommendation is on an existing view) which in some embodiments is defined by the following schema element:

```
  <xsd:complexType name=“ViewType”>
    <xsd:sequence>
      <xsd:element name=“Name” type=“xsd:string” />
      <xsd:element name=“ViewDefinition” minOccurs = “0”>
        <xsd:complexType>
          <xsd:simpleContent>
            <xsd:extension base = “xsd:string”>
              <xsd:attribute
name=“QUOTED_IDENTIFIER” type =“xsd:boolean” use=“optional”/>
              <xsd:attribute name=“ARITHABORT” type
=“xsd:boolean” use=“optional”/>
              <xsd:attribute
name=“CONCAT_NULL_YIELDS_NULL”
type =“xsd:boolean” use=“optional”/>
              <xsd:attribute name=“ANSI_NULLS” type
=“xsd:boolean” use=“optional”/>
              <xsd:attribute name=“ANSI_PADDING”
type =“xsd:boolean” use=“optional”/>
              <xsd:attribute name=“ANSI_WARNINGS”
type =“xsd:boolean” use=“optional”/>
              <xsd:attribute
name=“NUMERIC_ROUNDABORT” type =“xsd:boolean”
use=“optional”/>
            </xsd:extension>
          </xsd:simpleContent>
        </xsd:complexType>
      </xsd:element>
      <xsd:element name=“Recommendation”
type=“RecommendationType” minOccurs=“0” />
    </xsd:sequence>
  </xsd:complexType>
```

Recommendation Type (Could be Create, Drop) which in some embodiments is defined by the following schema element:

```
<xsd:complexType name=“RecommendationType”>
    <xsd:choice maxOccurs=“unbounded”>
        <xsd:element name=“Create” type=“CreateType” />
        <xsd:element name=“Drop” type=“DropType” />
    </xsd:choice>
<xsd:complexType>
```

Recommendation View Type (Only Create View Allowed) which in some embodiments is defined by the following schema element:

```
    <xsd:complexType name=“RecommendationViewType”>
        <xsd:sequence>
            <xsd:element name=“Create” type=“CreateViewType”
maxOccurs=“unbounded”/>
        </xsd:sequence>
    </xsd:complexType>
```

CreateType (<Create> (<Index> <View> <Statistics>); <PartitionFunction> <PartitionScheme> </Create> which in some embodiments is defined by the following schema element:

```
<xsd:complexType name=“CreateType”>
  <xsd:choice>
    <xsd:element name=“Index” type=“IndexType” />
    <xsd:element name=“Statistics” type=“StatisticsType” />
    </xsd:choice>
  </xsd:complexType>
    <!--
CreateViewype
  <xsd:complexType name=“CreateViewType”>
    <xsd:sequence>
      <xsd:element name=“View” type=“ViewType” />
    </xsd:sequence>
  </xsd:complexType>
DropType
  <xsd:complexType name=“DropType”>
    <xsd:sequence>
      <xsd:choice>
        <xsd:element name=“Index” type=“IndexType”/>
        <xsd:element name=“XMLIndex” type=“IndexType”/>
      </xsd:choice>
    </xsd:sequence>
  </xsd:complexType>
  <!--
Recommendation Type - FOR PARTITIONS
** Could be Create,Drop
  <xsd:complexType name=“RecommendationPType”>
    <xsd:choice maxOccurs=“unbounded”>
      <xsd:element name=“Create” type=“CreatePType” minOccurs=“0”
maxOccurs=“unbounded” />
    </xsd:choice>
  </xsd:complexType>
  <!--
CreatePType
  <xsd:complexType name=“CreatePType”>
    <xsd:choice>
      <xsd:element name=“PartitionFunction”
      type=“PartitionFunctionType” />
      <xsd:element name=“PartitionScheme”
      type=“PartitionSchemeType” />
    </xsd:choice>
  </xsd:complexType>
  <!--
  Index
** PartitionColumns - columns on which the
** table will be partitoned
  <xsd:complexType name=“IndexType”>
    <xsd:sequence>
      <xsd:element name=“Name” type=“xsd:string” />
      <xsd:element name=“Column” type=“ColumnType”
minOccurs=“0” maxOccurs=“1024” />
      <xsd:choice>
        <xsd:sequence>
          <xsd:element name=“PartitionScheme” type=“xsd:string”
/>
          <xsd:element name=“PartitionColumn”
type=“ColumnType” maxOccurs=“1024” />
        </xsd:sequence>
        <xsd:sequence>
          <xsd:element name=“FileGroup” type=“xsd:string”
minOccurs=“0”/>
        </xsd:sequence>
      </xsd:choice>
    </xsd:sequence>
    <xsd:attribute name=“Clustered” type=“xsd:boolean” use=“optional”
default=“false” />
    <xsd:attribute name=“Unique” type=“xsd:boolean” use=“optional”
default=“false” />
    <xsd:attribute name=“Online” type=“xsd:boolean” use=“optional”
default=“false” />
    <xsd:attribute name=“IndexSizeInMB” type=“xsd:double” />
  </xsd:complexType>
  <!--
Statistics
  <xsd:complexType name=“StatisticsType”>
    <xsd:sequence>
      <xsd:element name=“Name” type=“xsd:string” />
      <xsd:choice minOccurs =“0”>
        <xsd:element name=“FullScan” />
        <xsd:element name=“SamplePercentage”
type=“xsd:unsignedInt” />
        <xsd:element name=“SampleRows” type=“xsd:long” />
      </xsd:choice>
      <xsd:element name=“Column” type=“ColumnType”
      maxOccurs=“16” />
    </xsd:sequence>
  </xsd:complexType>
  <!--
1.) PartitionFunctionType
  <xsd:complexType name=“PartitionFunctionType”>
    <xsd:sequence>
      <xsd:element name=“Name” type=“xsd:string” />
      <xsd:element name=“ArgumentToFunction” type=“xsd:string”
maxOccurs=“1024” />
      <xsd:element name=“PartitionType” type=“PartitionType”/>
    </xsd:sequence>
  </xsd:complexType>
```

PartitionType can be Range or Hash which in some embodiments is defined by the following schema element:

```
<xsd:complexType name=“PartitionType”>
    <xsd:choice>
        <xsd:element name=“Range” type=“RangeType” />
        <xsd:element name=“Hash” type=“HashType” />
    </xsd:choice>
</xsd:complexType>
```

Range Type—Can have LEFT/RIGHT Boundary values. Unbounded as one can have as many partitions which in some embodiments is defined by the following schema element:

```
<xsd:complexType name=“RangeType”>
    <xsd:sequence maxOccurs=“unbounded”>
        <xsd:element name=“Value” type=“xsd:string” />
    </xsd:sequence>
    <xsd:attribute name=“Boundary” use=“optional”>
        <xsd:simpleType>
            <xsd:restriction base=“xsd:string”>
                <xsd:enumeration value=“Left” />
                <xsd:enumeration value=“Right” />
            </xsd:restriction>
        </xsd:simpleType>
    </xsd:attribute>
</xsd:complexType>
```

Hash type Value here refers to Number of Partitions which in some embodiments is defined by the following schema element:

```
<xsd:complexType name=“HashType”>
    <xsd:sequence>
        <xsd:element name=“NumberOfPartitions”
        type=“xsd:unsignedInt” />
    </xsd:sequence>
</xsd:complexType>
```

PartitionSchemeType which in some embodiments is defined by the following schema element:

```
      <xsd:complexType name=“PartitionSchemeType”>
            <xsd:sequence>
                  <xsd:element name=“Name” type=“xsd:string” />
                  <xsd:element name=“PartitionFunction”
                  type=“xsd:string” />
                  <xsd:element name=“FileGroup” type=“xsd:string”
maxOccurs=“unbounded” />
            </xsd:sequence>
      </xsd:complexType>
```

Column which in some embodiments is defined by the following schema element:

```
      <xsd:complexType name=“ColumnType”>
            <xsd:sequence>
                  <xsd:element name=“Name” type=“xsd:string” />
            </xsd:sequence>
            <xsd:attribute name=“Type” type=“ColType”
            use=“optional” />
            <xsd:attribute name=“SortOrder” type=“SortOrderType”
default=“Ascending” use=“optional”/>
      </xsd:complexType>
```

AnalysisReport Note about Tuning Summary report: This is generated from the schema of the <HEADERTYPE> </HEADERTYPE> subtree, which in some embodiments is defined by the following schema element:

```
      <xsd:complexType name=“AnalysisReportType”>
            <xsd:sequence>
                  <xsd:element name=“QueryCost” type=“QueryCostType”
minOccurs=“0” />
                  <xsd:element name=“EventFrequency” type=“EventFrequencyType”
minOccurs=“0” />
                  <xsd:element name=“QueryDetail” type=“QueryDetailType”
minOccurs=“0” />
                  <xsd:element name=“QueryIndexRelations”
type=“QueryIndexRelationsType” minOccurs=“0” maxOccurs=“2” />
                  <xsd:element name=“QueryCostRange” type=“QueryCostRangeType”
minOccurs=“0” maxOccurs=“2” />
                  <xsd:element name=“IndexUsage” type=“IndexUsageReportType”
minOccurs=“0” maxOccurs=“2” />
                  <xsd:element name=“IndexDetail” type=“IndexDetailType”
minOccurs=“0” />
                  <xsd:element name=“IndexBenefit” type=“IndexBenefitType”
minOccurs=“0” />
                  <xsd:element name=“ViewTableRelations”
type=“ViewTableRelationsType” minOccurs=“0” />
                  <xsd:element name=“WorkLoadAnalysis”
type=“WorkLoadAnalysisType” minOccurs=“0” />
                  <xsd:element name=“WorkLoadDetail” type=“WorkLoadDetailType”
minOccurs=“0” />
                  <xsd:element name=“FrequentTableSet” type=“FrequentTableSetType”
minOccurs=“0” />
            </xsd:sequence>
      </xsd:complexType>
```

Query Cost Report—Identical to Query Savings which in some embodiments is defined by the following schema element:

```
    <xsd:complexType name=“QueryCostType”>
        <xsd:sequence maxOccurs=“unbounded”>
            <xsd:element name=“row”>
                <xsd:complexType>
                    <xsd:attribute name=“StatementString”
                    type=“xsd:string”/>
                    <xsd:attribute name=“PercentImprovement”
type=“xsd:double”/>
                </xsd:complexType>
            </xsd:element>
        </xsd:sequence>
    </xsd:complexType>
```

Event Frequency Report which in some embodiments is defined by the following schema element:

```
<xsd:complexType name=“EventFrequencyType”>
    <xsd:sequence maxOccurs=“unbounded”>
        <xsd:element name=“row”>
            <xsd:complexType>
                <xsd:attribute name=“Event” type=“xsd:string” />
                <xsd:attribute name=“Frequency” type=“xsd:string” />
            </xsd:complexType>
        </xsd:element>
    </xsd:sequence>
</xsd:complexType>
```

Query Detail Report which in some embodiments is defined by the following schema element:

```
    <xsd:complexType name=“QueryDetailType”>
        <xsd:sequence maxOccurs=“unbounded”>
            <xsd:element name=“row”>
                <xsd:complexType>
                    <xsd:attribute name=“QueryID”
                    type=“xsd:integer” />
                    <xsd:attribute name=“Type” type=“xsd:string” />
                    <xsd:attribute name=“CurrentCost”
                    type=“xsd:float” />
                    <xsd:attribute name=“RecommendedCost”
type=“xsd:float” />
                    <xsd:attribute name=“Frequency”
                    type=“xsd:integer” />
                    <xsd:attribute name=“StatementString”
type=“xsd:string” />
                </xsd:complexType>
            </xsd:element>
        </xsd:sequence>
    </xsd:complexType>
```

Query Index Relations Report—2 reports which in some embodiments is defined by the following schema element:

```
        <QueryIndexRelations CurrentOrRecommended = “Current”>
            <Query>q1</Query>
            <IndexesUsed>i1,i2,i3</IndexesUsed>
            <Query>q2</Query>
            <IndexesUsed>i1</IndexesUsed>
        </QueryIndexRelations>
    <xsd:complexType name=“QueryIndexRelationsType”>
        <xsd:sequence maxOccurs=“unbounded”>
            <xsd:element name=“row”>
                <xsd:complexType>
                    <xsd:attribute name=“StatementString”
type=“xsd:string” />
                    <xsd:attribute name=“TableName”
                    type=“xsd:string” />
                    <xsd:attribute name=“IndexName”
                    type=“xsd:string” />
                    <xsd:attribute name=“IsClustered”
                    type=“xsd:boolean” />
                    <xsd:attribute name=“IsUnique”
                    type=“xsd:boolean” />
                </xsd:complexType>
            </xsd:element>
        </xsd:sequence>
    </xsd:complexType>
```

Query Cost Range Report which in some embodiments is defined by the following schema element:

```
<xsd:complexType name=“QueryCostRangeType”>
    <xsd:sequence maxOccurs=“unbounded”>
        <xsd:element name=“Range” type=“xsd:string” />
        <xsd:element name=“NumberOfQueries” type=“xsd:string” />
    </xsd:sequence>
</xsd:complexType>
```

Index Usage Report which in some embodiments is defined by the following schema element:

```
        <IndexUsage CurrentOrRecommended = “Current”>
            <BaseObject>
                <Name>Table1</Name>
                <IndexUsed>
                    <Name>idx1</Name>
                    <PercentageUsed>34</PercentageUsed>
                </IndexUsed>
                <IndexUsed>
                    <Name>idx2</Name>
                    <PercentageUsed>11</PercentageUsed>
                </IndexUsed>
            </BaseObject>
            <BaseObject>
                <Name>Table2</Name>
                <IndexUsed>
                    <Name>idx2</Name>
                    <PercentageUsed>23</PercentageUsed>
                </IndexUsed>
            </BaseObject>
        </IndexUsage>
    <xsd:complexType name=“BaseIndexUsageReportType”>
        <xsd:sequence>
            <xsd:element name=“BaseObject” type=“BaseObjectType”
maxOccurs=“unbounded” />
        </xsd:sequence>
    </xsd:complexType>
    <xsd:complexType name=“BaseObjectType”>
        <xsd:sequence>
            <xsd:element name=“Name” type=“xsd:string” />
            <xsd:element name=“IndexUsed” type=“IndexUsedType”
maxOccurs=“unbounded” />
        </xsd:sequence>
    </xsd:complexType>
    <xsd:complexType name=“IndexUsedType”>
        <xsd:sequence>
            <xsd:element name=“Name” type=“xsd:string” />
            <xsd:element name=“PercentageUsed” type=“xsd:string” />
        </xsd:sequence>
    </xsd:complexType>
    <xsd:complexType name=“IndexUsageReportType”>
        <xsd:complexContent>
            <xsd:extension base=“BaseIndexUsageReportType”>
                <xsd:attribute name=“CurrentOrRecommended”
type=“CurrentOrRecommendedType” use=“required” />
            </xsd:extension>
        </xsd:complexContent>
    </xsd:complexType>
```

Index Detail Report which in some embodiments is defined by the following schema element:

```
    <xsd:complexType name=“IndexDetailType”>
        <xsd:sequence maxOccurs=“unbounded”>
            <xsd:element name=“Name” type=“xsd:string” />
            <xsd:element name=“ColumnsInIndex”
            type=“xsd:string” />
            <xsd:element name=“Storage” type=“xsd:string” />
            <xsd:element name=“ExistingIndex” type=“xsd:string” />
            <xsd:element name=“PercentageUse” type=“xsd:string” />
            <xsd:element name=“PartitionFunction” type=“xsd:string”
minOccurs=“0” />
            <xsd:element name=“PartitionScheme” type=“xsd:string”
minOccurs=“0” />
            <xsd:element name=“IndexProperty” type=“xsd:string”
            minOccurs=“0” />
            <xsd:element name=“IndexOnObject” type=“xsd:string”
minOccurs=“0” />
            <xsd:element name=“ViewDefinition” type=“xsd:string”
minOccurs=“0” />
            <xsd:element name=“TablesReferencedByView”
type=“xsd:string” minOccurs=“0” />
            <xsd:element name=“NumberOfRows”
            type=“xsd:string” />
        </xsd:sequence>
    </xsd:complexType>
```

View Table Relations Record which in some embodiments is defined by the following schema element:

```
<xsd:complexType name=“ViewTableRelationsType”>
    <xsd:sequence maxOccurs=“unbounded”>
        <xsd:element name=“row”>
            <xsd:complexType>
                <xsd:attribute name=“TableSchema”
                type=“xsd:string” />
                <xsd:attribute name=“TableName”
                type=“xsd:string” />
                <xsd:attribute name=“ViewSchema”
                type=“xsd:string” />
                <xsd:attribute name=“ViewName”
                type=“xsd:string” />
            </xsd:complexType>
        </xsd:element>
    </xsd:sequence>
</xsd:complexType>
```

Index Benefit Report

```
    <xsd:complexType name=“NameRecommendationType”>
        <xsd:simpleContent>
            <xsd:extension base=“xsd:string”>
                <xsd:attribute name=“Recommendation”
type=“RecommendationAttributeType” use=“optional”
default=“Create” />
            </xsd:extension>
        </xsd:simpleContent>
    </xsd:complexType>
    <xsd:complexType name=“IndexBenefitType”>
        <xsd:sequence maxOccurs=“unbounded”>
            <xsd:element name=“Name”
            type=“NameRecommendationType” />
            <xsd:element name=“PercentageReductionInCost”
            type=“xsd:string” />
        </xsd:sequence>
    </xsd:complexType>
```

Workload Analysis Report which in some embodiments is defined by the following schema element:

```
  **
** <WorkloadAnalysis>
** <Query Type = “SELECT”>
            <NumberOfQueries>23</NumberOfQueries>
        </Query>
** <Query Type = “INSERT”>
            <NumberOfQueries>11</NumberOfQueries>
        </Query>
** <Query Type = “UPDATE”>
            <NumberOfQueries>12</NumberOfQueries>
        </Query>
** <Query Type = “DELETE”>
            <NumberOfQueries>16</NumberOfQueries>
        </Query>
        </WorkloadAnalysis>
**
    <xsd:complexType name=“WorkLoadAnalysisType”>
        <xsd:sequence maxOccurs=“unbounded”>
            <xsd:element name=“row”>
                <xsd:complexType>
                    <xsd:attribute name=“StatementType”
                    type=“xsd:string” />
                    <xsd:attribute name=“NumberOfQueries”
                    type=“xsd:int” />
                    <xsd:attribute name=
“NumberOfQueriesCostDecreased” type=“xsd:int” />
                    <xsd:attribute name=
“NumberOfQueriesCostIncreased” type=“xsd:int” />
                    <xsd:attribute
name=“NumberOfQueriesWithNoCostChange” type=“xsd:int” />
                </xsd:complexType>
            </xsd:element>
        </xsd:sequence>
    </xsd:complexType>
```

Workload Detail Report which in some embodiments is defined by the following schema element:

```
    <xsd:complexType name=“WorkLoadDetailType”>
        <xsd:sequence>
            <xsd:element name=“NameOfWorkload” type=“xsd:string”
minOccurs=“0” />
            <xsd:element name=“NumberOfEvents” type=“xsd:string”
minOccurs=“0” />
            <xsd:element name=“NumberOfEventsTuned”
type=“xsd:string” minOccurs=“0” />
            <xsd:element name=“NumberOfUnParsedEvents”
type=“xsd:string” minOccurs=“0” />
            <xsd:element name=“NumberOfStatementsTuned”
type=“xsd:string” minOccurs=“0” />
            <xsd:element name=“NumberOfDatabasesReferenced”
type=“xsd:string” minOccurs=“0” />
        </xsd:sequence>
    </xsd:complexType>
```

Frequent Table Set Report which in some embodiments is defined by the following schema element:

```
<xsd:complexType name=“FrequentTableSetType”>
    <xsd:sequence minOccurs=“0” maxOccurs=“unbounded”>
        <xsd:element name=“TablesReferencedTogether”
        type=“xsd:string” />
        <xsd:element name=“Frequency” type=“xsd:string” />
        <xsd:element name=“CostFrequency” type=“xsd:string” />
    </xsd:sequence>
</xsd:complexType>
```

Simple Types which in some embodiments is defined by the following schema element:

```
    <xsd:simpleType name=“IndexOnObjectType”>
        <xsd:restriction base=“xsd:string”>
            <xsd:enumeration value=“Table” />
            <xsd:enumeration value=“View” />
            <xsd:enumeration value=“PartitionScheme” />
        </xsd:restriction>
    </xsd:simpleType>
    <xsd:simpleType name=“SortOrderType”>
        <xsd:restriction base=“xsd:string”>
            <xsd:enumeration value=“Ascending” />
            <xsd:enumeration value=“Descending” />
        </xsd:restriction>
    </xsd:simpleType>
    <xsd:simpleType name=“IntervalType”>
        <xsd:restriction base=“xsd:string”>
            <xsd:enumeration value=“None” />
            <xsd:enumeration value=“Left” />
            <xsd:enumeration value=“Right” />
        </xsd:restriction>
    </xsd:simpleType>
    <xsd:simpleType name=“CurrentOrRecommendedType”>
        <xsd:restriction base=“xsd:string”>
            <xsd:enumeration value=“Current” />
            <xsd:enumeration value=“Recommended” />
        </xsd:restriction>
    </xsd:simpleType>
    <xsd:simpleType name=“SpecificationModeType”>
        <xsd:restriction base=“xsd:string”>
            <xsd:pattern value=“Relative” />
            <xsd:pattern value=“Absolute” />
        </xsd:restriction>
    </xsd:simpleType>
    <xsd:simpleType name=“ColType”>
        <xsd:restriction base=“xsd:string”>
            <xsd:enumeration value=“KeyColumn” />
            <xsd:enumeration value=“IncludedColumn” />
        </xsd:restriction>
    </xsd:simpleType>
    <xsd:simpleType name=“QueryTypeAttribute”>
        <xsd:restriction base=“xsd:string”>
            <xsd:enumeration value=“Select” />
            <xsd:enumeration value=“Insert” />
            <xsd:enumeration value=“Update” />
            <xsd:enumeration value=“Delete” />
        </xsd:restriction>
    </xsd:simpleType>
    <xsd:simpleType name=“RecommendationAttributeType”>
        <xsd:restriction base=“xsd:string”>
            <xsd:enumeration value=“Create” />
            <xsd:enumeration value=“Drop” />
        </xsd:restriction>
    </xsd:simpleType>
</xsd:schema>
```

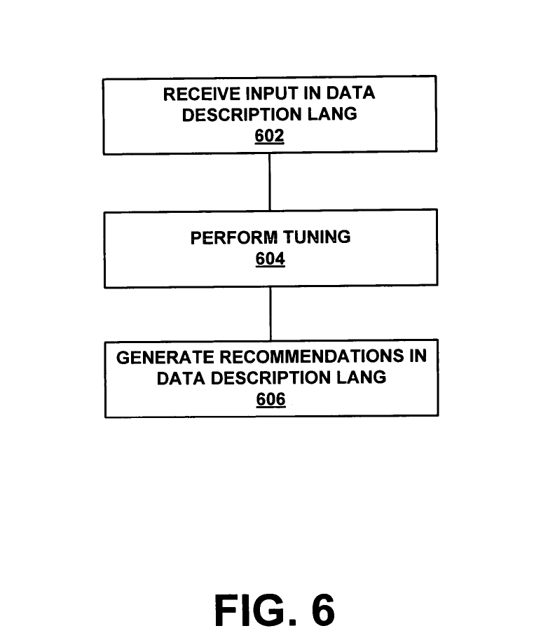

FIG. 6 is a flow diagram of an exemplary method for database tuning in which communications between internal and external components of the database tuning tool are conducted in a data description language such as, but not limited to XML in accordance with some embodiments of the invention. At step 602 a database tuning advisor such as the database tuning advisor described with respect to FIG. 2 receives one or more inputs. In some embodiments of the invention, the input is received in a data description language such as XML. In other embodiments, the input is converted into a standard form, such as a data description language such as but not limited to XML. The inputs may comply with a schema written in a schema language such as XSD. In some embodiments of the invention, the inputs include one or more of: one or more databases to be tuned, one or more tuning options and a workload. The database tuning advisor may be invoked from a user interface (e.g., a graphical user interface) or from a command-line executable.

In some embodiments of the invention, database tuning for a production server may be executed on a test server, thereby significantly reducing the load imposed on the production server. In some embodiments of the invention, metadata of the databases to be tuned is copied from the production server to the test server. It will be noted that data is not copied from the production server to the test server, only empty tables, indexes, views, stored procedures, triggers, etc. The metadata may be imported using scripting that typically accesses catalog entries and is not size-dependent.

In some embodiments of the invention, statistics required to perform database tuning may be imported from or created on the production server. Hardware parameters of the production server may be modeled on the test server so that the tuning recommendations determined are tuning recommendations for the production server, not the test server. Hence the recommendations produced by database tuning in accordance with the invention are the same as if the tuning were performed on the production server itself.

The database or databases may reside on a separate server or may reside on the same server as does the database tuning advisor. A workload may include a set of statements that execute against the database server(s). The statements may be written in a language for creating, updating and, querying relational database management systems, such as SQL, TSQL, etc. One or more of the statements in the workload may be associated with a weight representing the relative importance of the statement to the performance of the database system. A workload may be a file including an organization or industry benchmark, may be obtained from a profiling tool or may be generated in any suitable way.

Tuning options may include one or more of: a feature to be tuned, an alignment constraint, a partial physical configuration (e.g., a clustered index on a table, partitioning of a table or indexed view may be specified as required), a storage constraint (e.g., an upper bound of storage consumption), a time constraint and so on.

At step 604, the inputs may be submitted for tuning. Tuning may then be performed. Processing the inputs may involve creation of one or more physical structures such as tables and so on and may involve communications between multiple components of the database tuning tool. In some embodiments of the invention, communication between these components may be conducted in a data description language such as but not limited to XML. These communications may comply with a schema written in an appropriate schema language such as but not limited to XSD.

At step 606, a recommendation and/or report(s) may be generated. In some embodiments of the invention, the recommendations and/or reports(s) may be generated in a data description language such as but not limited to XML. The output may comply with a schema written in an appropriate schema language such as but not limited to XSD. The output may be input to step 604 to generate a new set of recommendations. The output may be edited prior to input to step 604.

In some embodiments of the invention, in response to receiving a workload that references more than one database, a recommendation for an appropriate physical design for all the databases referenced (e.g., a recommendation for the creation of one or more indexes, indexed views and partitioning for one or more of the databases referenced) may be generated. A recommendation for how available storage space should be allocated across databases may also be provided.

In accordance with some embodiments of the invention, partitioning recommendations and recommendations for required indexes and indexed views are made in concert, that is, the database tuning advisor may recommend one or more indexes, indexed views and partitioning in an integrated manner.

In some embodiments of the invention, in response to receiving a tuning option that specifies a “drop-only” mode, the database tuning advisor may evaluate usage of existing physical design objects for the given workload and may recommend dropping unused objects.

In response to receiving a tuning option that specifies that a table or index is to be partitioned, the database tuning advisor may recommend appropriate range partitioning of tables and indexes. In some embodiments of the invention, a tuning option may specify whether new indexes and indexed views (also referred to herein as objects) should be partitioned or not partitioned. If the option specifies that indexes and indexed views are to be partitioned, an alignment option may specify whether the partitioning of all indexes and indexed views on a table are to be aligned, as described below.

In some embodiments of the invention in response to receiving a desired configuration (e.g., a valid set of indexes, indexed views, and statistics), the recommendations generated conform to the desired configuration. The specified configuration may be complete (include all indexes, indexed views, etc. to be created) or partial (include one or more physical design feature to be included in the recommendations). In some embodiments of the invention, in response to receiving a tuning option specifying an evaluate mode, the performance of the given workload is evaluated (e.g., by consulting a query optimizer, or by executing embedded code, or by any other suitable means) for the configuration specified by the user and compared with the current configuration in the database. Thus, in this mode, DBAs may perform a what-if analysis of the physical design and assess its impact on the workload without actually changing the physical design of the database or executing the queries in the workload.

In some embodiments of the invention, in response to receiving a tuning option specifying a “must include” option, the indexes, indexed views, and statistics specified in the provided configuration are included. The database tuning advisor may additionally recommend other indexes, indexed views, etc. in addition to the specified configuration.

In some embodiments of the invention, in response to receiving a tuning option requesting secondary indexes on one or more XML columns, appropriate secondary indexes on the specified XML columns are provided. In some embodiments of the invention in response to receiving a request for secondary indexes on any XML columns, appropriate recommendations for secondary indexes on appropriate XML columns based on the workload are generated.

In some embodiments of the invention, the invoker of the method may be an owner (i.e., does not need to be a system administrator).

In some embodiments of the invention, recommendations may be provided for rebuilding or reorganizing indexes, as appropriate.

It will be appreciated that default tuning options may be invoked as appropriate.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A system for tuning a database comprising:
a database tuning tool, the database tuning tool receiving an input in a data description language, the input comprising at least one tuning option and at least one database to be tuned and in response to the input generating a recommendation in the data description language, the recommendation comprising a physical design recommendation.

2. The system of claim 1, wherein the data description language is XML.

3. The system of claim 1, wherein the input complies with a schema.

4. The system of claim 1, wherein the input complies with an XML schema.

5. The system of claim 1, wherein communication between components of the database tuning tool are conducted in the data description language.

6. The system of claim 3, wherein the schema defines an index and a table associated with the index.

7. The system of claim 6, wherein the index and the table are partitioned equivalently.

8. The system of claim 3, wherein the schema defines a specified configuration.

9. The system of claim 8, wherein the specified configuration is included in the recommendation.

10. The system of claim 3, wherein the schema defines a tuning option.

11. The system of claim 10, wherein the tuning option specifies that a usage of an object is to be evaluated and a recommendation for dropping the object is to be issued in response to determining that the object is unused.

12. The system of claim 1, wherein a report is generated, the report comprising a count and a percentage of a plurality of queries in a workload that reference a specified database.

13. The system of claim 1, wherein a report is generated, the report comprising statements in XML specifying a count and a percentage of a plurality of queries in a workload that reference a particular row in a table.

14. The system of claim 10, wherein the tuning option specifies an in-row length for a column in a table of the at least one database.

15. The system of claim 10, wherein the tuning option specifies that the recommendation comprises a list of indexes to be rebuilt.

16. The system of claim 10, wherein the tuning option specifies that the recommendation comprises a list of indexes to be reorganized.

17. A method for tuning a database comprising:
receiving an input, the input comprising at least one of a plurality of databases to be tuned, at least one tuning option and a workload, the at least one tuning option comprising statements in a data description language, the statements complying with a schema; and
in response to the input, generating a recommendation, the recommendation comprising a proposed physical design for the at least one database, the recommendation comprising statements in the data description language.

18. The method of claim 17, wherein the proposed physical design comprises at least one integrated recommendation for partitioning, creation of at least one index and creation of at least one indexed view.

19. The method of claim 17, wherein the data description language is XML.

20. The method of claim 17, wherein the schema is written in a schema language.

21. The method of claim 20, wherein the schema language is XSD.

22. The method of claim 17, wherein the at least one tuning option comprises a request to partition an index and a table associated with the index equivalently.

23. The method of claim 17, wherein the at least one tuning option comprises a specified configuration.

24. The method of claim 23, wherein the specified configuration is included in the recommendation.

25. The method of claim 17, wherein a recommendation of a physical structure is provided without generating the recommended physical structure.

26. The method of claim 17, wherein the at least one tuning option specifies that a secondary index for an XML column is to be recommended.

27. The method of claim 17, wherein the at least one tuning option specifies that a usage of an object is to be evaluated and a recommendation for dropping the object is to be issued in response to determining that the object is unused.

28. The method of claim 17, wherein the at least one tuning option specifies that a report is to be generated.

29. The method of claim 28, wherein the report comprises a count and a percentage of a plurality of queries in the workload that reference a specified database.

30. The method of claim 28, wherein the report comprises a count and a percentage of a plurality of queries in the workload that reference a particular row in a table.

31. The method of claim 28, wherein the report comprises a count and a percentage of a plurality of queries in the workload that reference a particular column in a table.

32. The method of claim 17, wherein the at least one tuning option specifies an in-row length for a column in a table of the at least one database.

33. The method of claim 32, wherein in response to determining that a value for the column exceeds the in-row length, a portion of the value exceeding the in-row length is stored in an overflow area.

34. The method of claim 17, wherein the recommendation comprises a proposal to rebuild an index.

35. The method of claim 24, wherein the recommendation comprises a proposal to reorganize an index.

36. A computer readable medium comprising computer-executable instructions for performing the method of claim 17.
